(19) United States
(12) Patent Application Publication
(10) Pub. No.: US 2025/0098559 A1
(43) Pub. Date: Mar. 27, 2025

(54) ADJUSTABLE HITCH BOLT PATTERN

(71) Applicant: CNH Industrial America LLC, New Holland, PA (US)

(72) Inventor: Todd Hertzler, New Holland, PA (US)

(73) Assignee: CNH Industrial America LLC, New Holland, PA (US)

(21) Appl. No.: 18/888,270

(22) Filed: Sep. 18, 2024

Related U.S. Application Data
(60) Provisional application No. 63/540,496, filed on Sep. 26, 2023.

(51) Int. Cl. A01B 59/042

(52) U.S. Cl. CPC A01B 59/042

(57) ABSTRACT

An agricultural machine tow hitch assembly includes: first and second hitch members, a pivot pin pivotally connecting the first and second hitch members, and an adjustment arrangement. The adjustment arrangement includes: a first semicircular slot extending through the first hitch member and being concentric with and located at a first radial distance from the pivot axis, a first adjustment connector configured to pass through the first semicircular slot to apply a respective clamping force between the first hitch member and the second hitch member, a second semicircular slot extending through the first hitch member and being concentric with and located at a second radial distance from the pivot axis, the second radial distance being greater than the first radial distance, and a second adjustment connector configured to pass through the second semicircular slot to apply a respective clamping force between the first hitch member and the second hitch member.

### CROSS-REFERENCE TO RELATED APPLICATION

This application claims priority to U.S. Provisional Patent Application Ser. No. 63/540,496, filed Sep. 26, 2023, the content of such application being incorporated by reference herein in its entirety.

### FIELD OF THE INVENTION

This patent application relates to towed agricultural equipment, such as balers and the like.

### BACKGROUND OF THE INVENTION

Various types of agricultural equipment are towed behind a powered machine (generically referred to herein as a “tractor”) during operation and transport of the equipment. For example, agricultural balers are often configured as a tow-behind machine that is pulled and powered by a tractor to perform the baling operation. The towed machine has a hitch that connectors to a drawbar on the tractor. The hitch may be adjustable in height to secure the towed machine to tractors having drawbars at different heights.

An example of an adjustable baler hitch adjustment assembly 10 is shown in FIG. 5. The hitch assembly 10 includes a hitch arm 12 that is secured to a hitch mount 14 that is secured to or formed as part of the baler frame 16. The hitch arm 12 is secured to the hitch mount 14 by a pivot connector 20 and a plurality of adjustment connectors 22. The pivot connector 20 defines or is collinear with a pivoting axis about which the hitch arm 12 pivots relative to the hitch mount 14. The adjustment connectors 22 surround the pivot connector 20 in a circular pattern, and each adjustment connector 22 is connected to the hitch arm 12 by passing it through a respective slot 24 formed in the hitch mount 14. The slots 24 define respective circular arcs that are centered about the pivot connector 20. Thus, the slots 24 provide a limited range of relative rotational movement between the hitch arm 12 and hitch mount 14. The hitch arm 12 is adjusted by loosening the adjustment connectors 22 and pivot connector 20, rotating the hitch arm 12 about the axis of the pivot connector 20, and then tightening all of the connectors 20, 22.

The inventors have determined that improvements can be made to conventional adjustable hitch bolt patterns, such as the one described in relation to FIG. 5.

This background is provided to assist with an understanding of the following explanations of exemplary embodiments, and is not an admission that any or all of this background information is necessarily prior art.

### SUMMARY OF THE INVENTION

In a first exemplary aspect, there is provided an agricultural machine tow hitch assembly comprising: a first hitch member; a second hitch member; a pivot pin pivotally connecting the first hitch member to the second hitch member and defining a pivot axis about which the first hitch member can pivot relative to the second hitch member; and an adjustment arrangement. The adjustment arrangement comprises: a first semicircular slot extending through the first hitch member, the first semicircular slot being concentric with and located at a first radial distance from the pivot axis, a first adjustment connector configured to pass through the first semicircular slot to apply a respective clamping force between the first hitch member and the second hitch member, a second semicircular slot extending through the first hitch member, the second semicircular slot being concentric with and located at a second radial distance from the pivot axis, the second radial distance being greater than the first radial distance, and a second adjustment connector configured to pass through the second semicircular slot to apply a respective clamping force between the first hitch member and the second hitch member.

In a second exemplary aspect, there is provided an agricultural machine comprising: a frame; wheels to configured to support the frame for movement along a surface; agricultural processing equipment operatively connected to the frame and configured to perform agricultural operations while the frame moves along the surface; and a tow hitch assembly. The tow hitch assembly comprises: a first hitch member; a second hitch member; a pivot pin pivotally connecting the first hitch member to the second hitch member and defining a pivot axis about which the first hitch member can pivot relative to the second hitch member; and an adjustment arrangement. The adjustment arrangement comprises: a first semicircular slot extending through the first hitch member, the first semicircular slot being concentric with and located at a first radial distance from the pivot axis, a first adjustment connector configured to pass through the first semicircular slot to apply a respective clamping force between the first hitch member and the second hitch member, a second semicircular slot extending through the first hitch member, the second semicircular slot being concentric with and located at a second radial distance from the pivot axis, the second radial distance being greater than the first radial distance, and a second adjustment connector configured to pass through the second semicircular slot to apply a respective clamping force between the first hitch member and the second hitch member.

### BRIEF DESCRIPTION OF THE DRAWINGS

Embodiments of inventions will now be described, strictly by way of example, with reference to the accompanying drawings, in which:

FIG. 1 illustrates an exemplary tractor and baler.

FIG. 2 is an isometric view of an exemplary embodiment of a towed agricultural equipment (e.g., baler) hitch assembly.

FIG. 3 is a detail view of the embodiment of FIG. 2.

FIG. 4 is a schematic side view of another exemplary embodiment of a towed agricultural equipment (e.g., baler) hitch assembly.

FIG. 5 is a schematic side view of a conventional baler hitch assembly.

In the figures, like reference numerals refer to the same or similar elements.

### DETAILED DESCRIPTION OF THE DRAWINGS

The terms “forward,” “rearward,” “left” and “right,” when used in connection with an agricultural vehicle or equipment, and/or components thereof, are usually determined with reference to the direction of forward operative travel of the agricultural vehicle and/or agricultural baler, but they should not be construed as limiting. The terms “longitudinal” and “transverse” are determined with reference to the fore-and-aft direction of the agricultural vehicle and/or agricultural baler and are equally not to be construed as limiting.

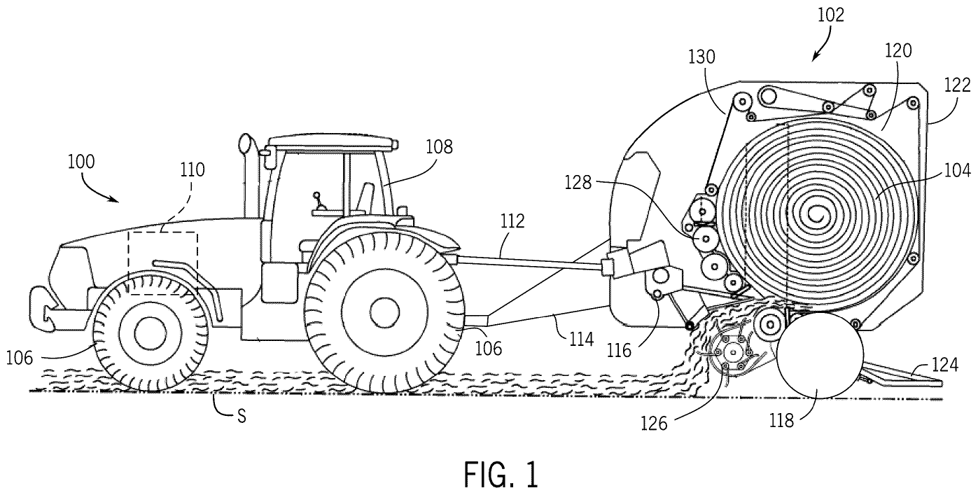

FIG. 1 shows an embodiment of an agricultural vehicle 100 (generically referred to as a “tractor” herein) towing an agricultural machine, which in this example is a baler 102, to perform an agricultural operation on a field surface S. The tractor 100 can be an operator-driven tractor 100, an autonomous tractor 100, or any other suitable vehicle configured to tow a baler or other agricultural processing equipment or machines across a surface.

The tractor 100 generally includes wheels 106, an operator cab 108, an engine 110, and a power take-off 112 that transmits power to the baler 102. A hitch assembly 114 connects the tractor 100 to the baler 102 so that the tractor 100 can pull the baler 102 across the field.

The baler 102 generally includes a frame 116 that is supported by wheels 118 to roll on the ground surface S, a baling chamber 120, a tailgate 122, and a ramp 124 that is movably mounted to the frame 116 generally below the baling chamber 120 to vertically support the bale 104 as it is ejected. The baler 102 also includes conventional baling equipment, such as a crop collector 126 to lift crop material from the ground, rollers 128 and belts 130 that manipulate the crop material into a bale 104, as known in the art, and mechanisms for wrapping the bale.

The shown baler 102 is configured as a round baler that forms round bales 104. However, in some embodiments, baler 102 may have any other suitable configuration, including being configured to generate square or rectangular bales.

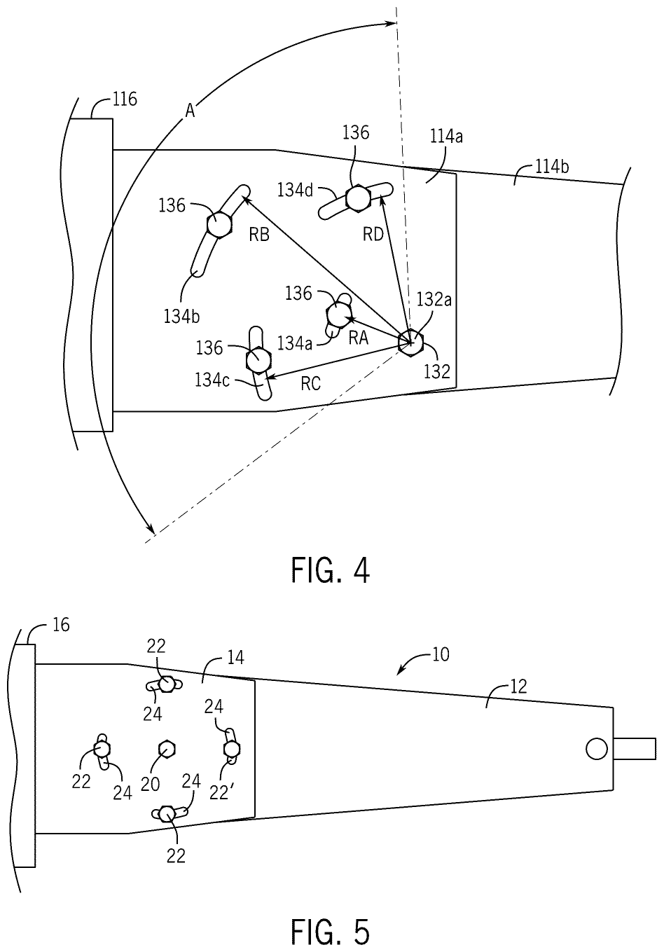

As noted above, the assembly 114 may be adjustable to multiple positions to connect to tractors 100 having different dimensions. It generally is desirable for it to be convenient and simple to make such adjustments. Devices such as hirth joints can be used, but these require lateral separation of the parts to clear the facing teeth of the two joint members, making the process more difficult. In other cases, such as shown in FIG. 4, a plurality of adjustment connectors 22 are located in a circular pattern, with each adjustment connector 22 being radially equidistant from a pivot connector 20. This design offers an intuitive and simple system for adjusting the angle of the hitch arm 12 relative to the hitch mount 14. However, the inventors have determined that designs such as this can have a limited ability to withstand torque loads, and therefore can slip under harsh operating conditions or when not properly secured.

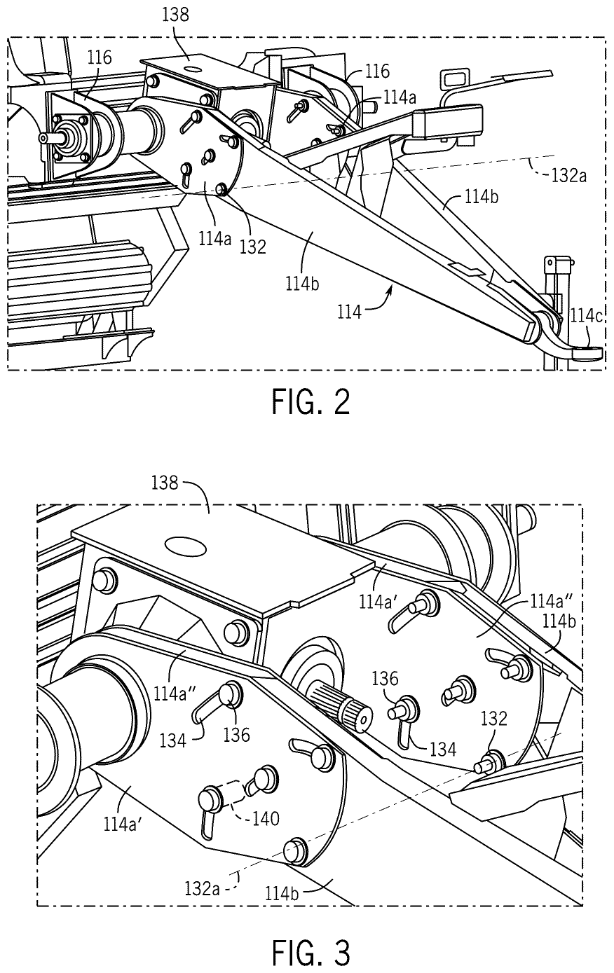

Referring now to FIGS. 2 and 3, an exemplary embodiment of an adjustable hitch assembly 114 is shown with a construction that is intended to address or mitigate issues with prior adjustable hitch assembly designs. Embodiments are described in relation to a towed agricultural machine in the form of an agricultural baler 102, such as shown in FIG. 1, but it will be appreciated that the baler 102 may be replaced by other types of towed agricultural machines.

The hitch assembly 114 generally includes a hitch mount 114a that is secured to or securable to a baler frame 116, a hitch arm 114b, and a pivot pin 132 that secures the hitch mount 114a to the hitch arm 114b. The pivot pin 132 defines a pivot axis 132a about which the hitch arm 114b rotates relative to the hitch mount 114a. The hitch arm 114b extends from a proximal end at the pivot pin 132 to a distal end that is configured to connect to a tractor 100. For example, the distal end may include a hitch tongue 114c that secures to the tractor drawbar, such as known in the art.

Referring to the detail view of FIG. 3 and schematic view of FIG. 4, the hitch assembly 114 also includes an adjustment arrangement comprising two or more slots 134, each having a respective adjustment connector 136. In this example, there are four slots 134 and four connectors 136, but other numbers may be used. It will also be understood that a slot 134 may have multiple connectors 136 located therein. For clarity, the slots 134 and respective adjustment connectors 136 are not shown in FIG. 2, and only one of the slots 134 and its respective adjustment connector 136 are identified with reference numbers in FIG. 3.

Each slot 134 extends through the hitch mount 114a and has a semicircular shape that is concentric with the pivot axis 132a. At least two of the slots 134 are located at different radial distances from the pivot axis 132a. For example, as shown in FIG. 4, a first slot 134a is located a first radial distance Ra from the pivot axis 132a, and a second slot 134b is located a second radial distance Rb from the pivot axis 132a, with the second radial distance Rb being greater than the first radial distance Ra.

The remaining slots 134 (if provided) may be located at other radial distances from the pivot axis 132a. In this example, a third slot 134c and a fourth slot 134d are provided, with each being at a respective radial distance Rc, Rd from the pivot axis 132a. In this case, the third radial distance Rc may be equal to the fourth radial distance Rd, and the third and fourth radial distances Rc, Rd may be greater than the first radial distance Ra, and less than the second radial distance Rb. Other alternatives and embodiments will be apparent to persons of ordinary skill in the art in view of the present disclosure.

The slots 134 may include a strictly arc-shaped opening, such as shown, but alternatively may include other shapes. For example a slot 134 may have an arc-shaped portion that defines a semicircular region that is concentric with the pivot axis 132, and also other portions that extend in other directions from the arc-shaped portion (e.g., a lobe or slot that extends radially from the arc-shaped portion).

The adjustment connectors 136 pass through the slots 134 and generate a clamping force to compress the hitch mount 114a and hitch arm 114b together, and thereby create friction to prevent the hitch arm 114b from rotating about the pivot pin 132 relative to the hitch mount 114a. In the shown embodiment, the adjustment connectors 136 comprise threaded bolts that engage corresponding threaded receptacles, such as threaded holes formed in the hitch arm 114b, or threaded nuts located on the opposite side of the hitch arm 114b. The adjustment connectors 136 are tightened to prevent relative rotation between the hitch mount 114a and hitch arm 114b, and loosened or removed to allow relative rotation between the hitch mount 114a and hitch arm 114b.

The pivot pin 132 may comprise any suitable structure, such as a simple pin that is inserted into collinear holes formed through the hitch mount 114a and hitch arm 114b and retained by clips or the like. In some embodiments, such as the illustrated examples, the pivot pin 132 may be formed as a threaded bolt that may be secured in a manner like the adjustment connectors 136. In this case, the pivot pin can also be tightened or loosened to selectively generate or not generate a respective clamping force to assist with preventing relative rotation between the hitch mount 114a and the hitch arm 114b. Other alternatives and embodiments will be apparent to persons of ordinary skill in the art in view of the present disclosure.

In use, the adjustment connectors 136 are secured to clamp the hitch mount 114a and hitch arm 114b together, and the friction generated by each adjustment connector 136 contributes to prevent relative rotation between the hitch mount 114 and the hitch arm 114b. The contribution against rotation provided by each adjustment connector 136 is a function of the clamping force (and therefore friction), and its radial distance from the pivot axis 132a. Providing one or more adjustment connectors 136 at a relatively great distance from the pivot axis 132a, such as the second adjustment connector 136b shown in FIG. 4, can increase the overall torque resistance of the adjustment arrangement as compared to a conventional circular pattern.

The benefits of this arrangement are expected to be particularly evident when the hitch mount 114a and hitch arm 114b are limited in size (e.g., due to special constraints of the surrounding structures, weight considerations, etc.), and constructed using conventional materials and fasteners. For example, assuming the hitch mount 114a and hitch arm 114b of FIG. 4 are the same size and general construction as the hitch mount 14 and hitch arm 12 of FIG. 5, and that the same types of fasteners are used in both cases, the arrangement of FIG. 4 is expected to provide a greater resistance against unwanted rotation of the hitch arm relative to the hitch mount. Thus, an arrangement such as shown in FIGS. 2-4 can be used to retrofit and improve existing equipment, in addition to being used in new constructions.

In one example of a retrofit use, an existing hitch assembly such as shown in FIG. 5 can be modified by replacing the hitch mount 14 with a hitch mount as shown in FIG. 4, with the pattern of the slots 134 being selected to match the existing bolt hole pattern of the existing hitch arm 12. In this case, one of the existing adjustment connectors, such as connector 22′ shown in FIG. 5, can be used as a pivot pin that passes through an appropriately sized round hole in the hitch mount 14, and the remaining connectors, including connector 20, can be located in slots that pass through the hitch mount 14 and are concentric to the pivot pin 22′.

In some embodiments, the adjustment connectors 136 may be arranged in a particular region extending about the pivot axis 132a as viewed along the pivot axis 132a (e.g., as shown in the view of FIG. 4). For example, in the embodiment of FIGS. 2-4, two or more (e.g., three or four) of the adjustment connectors 136 may be arranged in a region that extends through an angle A about the pivot axis 132a, with the angle A being no greater than 180 degrees, more preferably no greater than 120 degrees, and most preferably no greater than 90 degrees. For measurement of the dimensions herein, the position of each adjustment connector 136 is identified by the geometric center of the adjustment connector 136 (e.g., the cylindrical center of a threaded bolt). Furthermore, some embodiments preferably have no additional adjustment connectors 136 provided outside the single region defined by angle A.

Referring back to FIGS. 2 and 3, one or both of the hitch mount 114a and hitch arm 114b may comprise an assembly or collection of like or identical parts. For example, the hitch mount 114a may comprise spaced apart and generally mirror-image left and right components that are located (for example) on opposite sides of a gearbox 138 that connects to a power take-off shaft 112 from the tractor 100. Similarly, the hitch arm 114b may comprise generally mirror image left and right components that angle towards each other to join at the hitch tongue 114c.

The particular details of how the hitch mount 114a and hitch arm 114b contact each other can also vary. In the example of FIGS. 2 and 3, each left and right hitch mount 114a component comprises an outer plate 114a′ and an inner plate 114a″ that is parallel to the outer plate 114a′. The plates 114a′, 114a″ are located on opposite sides of the respective component of the hitch arm 114b. Each slot 134 passes through the plates 114a′, 114a″, such that an adjustment connector 136 such as a threaded bolt can pass through the slot 134 and be secured at opposite sides of the two plates 114a′, 114a″ between the bolt head and a threaded nut. In this case, the hitch arm 114b includes a respective hole 140 that overlaps the respective slot 134 to receive each adjustment connector 136. In this example, the hitch arm 114b is secured to the hitch mount 114a in a double-shear configuration, in which the adjustment connectors clamp the plates 114a′, 114a″ against opposite sides of the hitch arm 114b.

In another example, one of the inner and outer plates 114a′, 114a″ may be omitted, and the hitch arm 114b may have threaded holes into which threaded adjustment connectors 136 fit to clamp the hitch mount 114a and hitch arm 114b together. It will also be appreciated that the slots 134 may be provided in the hitch arm 114b, and corresponding holes may be provided through the hitch mount 114a, in an arrangement that is essentially the opposite of what is shown in FIGS. 2-3. Other alternatives and embodiments will be apparent to persons of ordinary skill in the art in view of the present disclosure.

The present disclosure describes a number of inventive features and/or combinations of features that may be used alone or in combination with each other or in combination with other technologies. Such features may be used in any useful combination, and the appearance of a particular feature in combination with another particular feature in the embodiments is not intended to suggest that such features cannot be used in alternative combinations with other features. The embodiments described herein are all exemplary, and are not intended to limit the scope of the claims. It will be appreciated that various aspects of the embodiments described herein may be provided as component parts or as subassemblies. It will also be appreciated that the inventions described herein can be modified and adapted in various ways, and all such modifications and adaptations are intended to be included in the scope of this disclosure and the appended claims.

It will also be understood that the description herein and the claims describe features that may be combined with other features not specifically described. Also, features identified in the singular or by a specific number are not intended to be limited to a single features or the described number of features unless specifically recited as being present only in the specified quantity.

1. An agricultural machine tow hitch assembly comprising:
a first hitch member;
a second hitch member;
a pivot pin pivotally connecting the first hitch member to the second hitch member and defining a pivot axis about which the first hitch member can pivot relative to the second hitch member; and
an adjustment arrangement comprising:
a first semicircular slot extending through the first hitch member, the first semicircular slot being concentric with and located at a first radial distance from the pivot axis,
a first adjustment connector configured to pass through the first semicircular slot to apply a respective clamping force between the first hitch member and the second hitch member,
a second semicircular slot extending through the first hitch member, the second semicircular slot being concentric with and located at a second radial distance from the pivot axis, the second radial distance being greater than the first radial distance, and
a second adjustment connector configured to pass through the second semicircular slot to apply a respective clamping force between the first hitch member and the second hitch member.

2. The agricultural machine tow hitch assembly of claim 1, wherein the first hitch member comprises a hitch mount secured to a towed agricultural machine, and the second hitch member comprises a hitch arm having a proximal end located at the pivot pin and a distal end configured to secure to an agricultural tractor.

3. The agricultural machine tow hitch assembly of claim 1, wherein the second hitch member comprises a hitch mount secured to a towed agricultural machine, and the first hitch member comprises a hitch arm having a proximal end located at the pivot pin and a distal end configured to secure to an agricultural tractor.

4. The agricultural machine tow hitch assembly of claim 1, wherein the pivot pin comprises an adjustable fastener configured to selectively apply and not apply a respective clamping force between the first hitch member and the second hitch member.

5. The agricultural machine tow hitch assembly of claim 1, wherein the first adjustment connector and the second adjustment connector are located in a single region extending no greater than 180 degrees about the pivot axis as viewed along the pivot axis.

6. The agricultural machine tow hitch assembly of claim 1, further comprising:
a third semicircular slot extending through the first hitch member, the first semicircular slot being concentric with and located at a third radial distance from the pivot axis, the third radial distance being different in magnitude than at least one of the first radial distance and the second radial distance; and
a third adjustment connector configured to pass through the third semicircular slot to apply a respective clamping force between the first hitch member and the second hitch member.

7. The agricultural machine tow hitch assembly of claim 6, wherein the first adjustment connector, the second adjustment connector and the third adjustment connector are located in a single region extending no greater than 120 degrees about the pivot axis as viewed along the pivot axis.

8. The agricultural machine tow hitch assembly of claim 6, wherein the first adjustment connector, the second adjustment connector and the third adjustment connector are located in a single region extending no greater than 90 degrees about the pivot axis as viewed along the pivot axis.

9. The agricultural machine tow hitch assembly of claim 6, further comprising:
a fourth semicircular slot extending through the first hitch member, the first semicircular slot being concentric with and located at a fourth radial distance from the pivot axis, the fourth radial distance being different in magnitude than at least one of the first radial distance and the second radial distance; and
a fourth adjustment connector configured to pass through the fourth semicircular slot to apply a respective clamping force between the first hitch member and the second hitch member.

10. The agricultural machine tow hitch assembly of claim 9, wherein the first adjustment connector, the second adjustment connector, the third adjustment connector and the fourth adjustment connector are located in a single region extending no greater than 120 degrees about the pivot axis as viewed along the pivot axis.

11. The agricultural machine tow hitch assembly of claim 9, wherein the first adjustment connector, the second adjustment connector, the third adjustment connector and the fourth adjustment connector are located in a single region extending no greater than 90 degrees about the pivot axis as viewed along the pivot axis.

12. The agricultural machine tow hitch assembly of claim 11, wherein no additional adjustment connectors are located outside the single region.

13. The agricultural machine tow hitch assembly of claim 1, wherein the first hitch member comprises first and second parallel plates, the first semicircular slot extends through the first plate and the second plate, and the second semicircular slot extends through the first plate and the second plate.

14. The agricultural machine tow hitch assembly of claim 13, wherein the second hitch member comprises a first hole overlapping the first semicircular slot and a second hole overlapping the second semicircular slot, and the first adjustment connector and the second adjustment connector comprise respective bolts and nuts configured to clamp the second hitch member between the first and second parallel plates.

15. An agricultural machine comprising:
a frame;
wheels to configured to support the frame for movement along a surface;
agricultural processing equipment operatively connected to the frame and configured to perform agricultural operations while the frame moves along the surface; and
a tow hitch assembly comprising:
a first hitch member;
a second hitch member;
a pivot pin pivotally connecting the first hitch member to the second hitch member and defining a pivot axis about which the first hitch member can pivot relative to the second hitch member; and
an adjustment arrangement comprising:
a first semicircular slot extending through the first hitch member, the first semicircular slot being concentric with and located at a first radial distance from the pivot axis,
a first adjustment connector configured to pass through the first semicircular slot to apply a respective clamping force between the first hitch member and the second hitch member,
a second semicircular slot extending through the first hitch member, the second semicircular slot being concentric with and located at a second radial distance from the pivot axis, the second radial distance being greater than the first radial distance, and
a second adjustment connector configured to pass through the second semicircular slot to apply a respective clamping force between the first hitch member and the second hitch member.
